(19) United States
(12) Patent Application Publication
(10) Pub. No.: US 2011/0081465 A1
(43) Pub. Date: Apr. 7, 2011

(54) MASALA POPCORN

(76) Inventors: Hiral Kiritkumar Patel, San Jose, CA (US); Pankaj Kiritkumar Patel, Gastonia, NC (US)

(21) Appl. No.: 12/575,326

(22) Filed: Oct. 7, 2009

(51) Int. Cl. A23L 1/18; A23L 1/10; A23L 1/164

(52) U.S. Cl. 426/241; 426/627; 426/625; 426/438

(57) ABSTRACT

A spicy popcorn is composed of, in composition of weight, fifty percent to seventy percent popped corn kernels, five percent to forty percent oil, one half percent to eight percent turmeric, less than one half percent to eight percent pepper and one to thirteen percent additional seasoning

### BACKGROUND

Corn kernels are composed of dense starch surrounded by a hard moisture sealed hull. Upon heating pressure builds up inside the kernel until an explosive “pop” occurs resulting in what is popularly known as popcorn or popping corn. Popcorn is a popular snacking food typically seasoned with salt and butter.

Popcorn is sometimes flavored to add a distinct taste. For example, it is common to flavor popcorn with caramel to produce what is popularly called caramel corn. Popcorn is also combined with fruit flavors, cinnamon and so on. U.S. Pat. No. 6,207,205 B1, issued Mar. 27, 2001 to Kiritkumar J. Patel, et al., describes preparation of spicy popcorn with natural ingredients.

### BRIEF DESCRIPTION OF THE DRAWING

FIG. 1 is a simplified diagram illustrating preparation of spicy popcorn according to an embodiment of the invention.

### DESCRIPTION OF THE EMBODIMENT

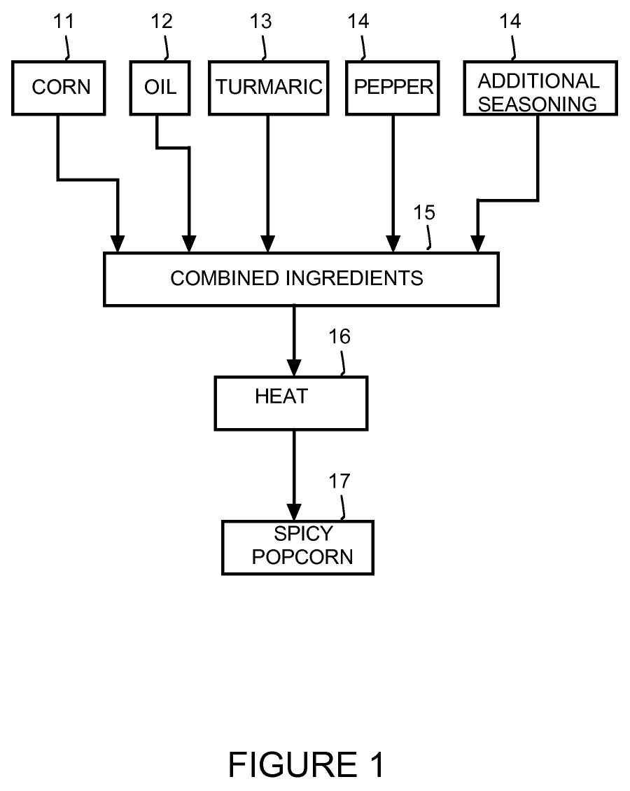

FIG. 1 illustrates preparation of spicy popcorn 17. Combined ingredients 16 for the spicy popcorn 17 include corn 11, oil 12, turmeric 13, pepper 14 and additional seasoning 15. For example, combined ingredients 16 contains, by weight, fifty percent to seventy percent corn 11, five percent to forty percent oil 12, one half percent to eight percent turmeric 13, one half percent to eight percent pepper 14 and one to thirteen percent additional seasoning 15.

For example, corn 11 can consist of any type of corn kernel that is encased by a hard moisture sealed hull and thus able to be “popped”. Oil 12 can be composed of a cooking oil such as palm oil, corn oil, vegetable oil, olive oil, canola oil, coconut oil, flax seed oil, grapeseed oil, hazelnut oil, peanut oil, safflower oil, sesame oil, sunflower oil, walnut oil, butter, clarified butter, rice bran oil, cottonseed oil, lard, margarine, diacylglycerol oil, soybean oil, et cetera, or a combination of different cooking oils.

Pepper 14 can include one or more of black pepper, red pepper, green pepper, jalapeno pepper, cayenne pepper, chili pepper, Serrano pepper, Tabasco pepper, Thai pepper, rocoto pepper, and so on.

Additional seasonings 15 typically include one or more of natural salt, sea salt, and iodized salt. A typical amount of salt by weight is one percent to eight percent of combined ingredients 16. Additional ingredients can also contain, for example, garlic powder, onion powder or other seasonings. A typical amount of garlic powder, if included, is one half percent to five percent of combined ingredients 16. Likewise, a typical amount of onion powder, if included, is one half percent to five percent of combined ingredients 16.

To the combined ingredients 16, heat 17 is applied to produce spicy popcorn 17. The heat is applied, for example, by a popcorn popper, a microwave oven, a commercial popcorn machine or a kettle on a stove top.

For example, to prepare for heating using a microwave oven, oil 12, turmeric 13, pepper 14 and additional seasoning 15 can be combined into a slurry and then poured into a bag separately from the corn 11. Alternatively, corn 11, oil 12, turmeric 13, pepper 14 and additional seasoning 15 can be combined together before being poured into a bag, or corn 11, oil 12, turmeric 13, pepper 14 and additional seasoning 15 can all be combined together by separately pouring each ingredient into a bag and then mixing.

For example, to prepare for heating using a kettle on a stove, oil 12, turmeric 13, pepper 14 and additional seasoning 15 can be combined into a slurry and then poured into the kettle separately from corn 11. The slurry can be heated before or after adding corn 11. Alternatively, oil 12 alone or in combination with a subset of turmeric 13, pepper 14 and additional seasoning 15 can be heated in a kettle before adding the remaining of combined ingredients 16. Alternatively, corn 11 can be popped in a kettle before being combined with the remaining of combined ingredients 16.

While FIG. 1 shows corn 11 being mixed with the remaining combined ingredients 16, corn 11 can be combined with only a subset of the ingredients, popped, and then combined with the remaining ingredients. For example, corn 11 can be popped separately by a microwave, a commercial popcorn popper, a kettle on a stove, or by some other means. Once popped, corn 11 can then be mixed with oil 12, turmeric 13, pepper 14 and additional seasoning 15 mixed as a slurry. Corn 11 can also, for example, be mixed with oil 12, popped and then covered with a powdered combination of turmeric 13, pepper 14 and additional seasoning 15.

The turmeric 13, pepper 14 and additional seasoning 15 form a Masala flavor that provides a unique flavor. The amount of pepper 14 can be varied to lessen or increase the level of hot spiciness.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

We claim:

1. An unpopped composition of popcorn comprising in composition of weight:
fifty percent to seventy percent corn kernels;
five percent to forty percent cooking oil;
one half percent to eight percent turmeric;
less than one half percent to eight percent pepper; and,
one to thirteen percent additional seasoning.

2. An unpopped composition of popcorn as in claim 1 wherein the cooking oil includes at least one of the following cooking oils: palm oil, corn oil, vegetable oil, olive oil, canola oil, coconut oil, flax seed oil, grapeseed oil, hazelnut oil, peanut oil, safflower oil, sesame oil, sunflower oil, walnut oil, butter, clarified butter, rice bran oil, cottonseed oil, lard, margarine, diacylglycerol oil, soybean oil.

3. An unpopped composition of popcorn as in claim 1 wherein the pepper includes at least one of the following peppers: black pepper, red pepper, green pepper, jalapeno pepper, cayenne pepper, chili pepper, Serrano pepper, Tabasco pepper, Thai pepper, rocoto pepper.

4. An unpopped composition as in claim 1 wherein the additional seasoning includes at least one of the following: salt, garlic, onion.

5. Spicy popcorn comprising in composition of weight:
fifty percent to seventy percent popped corn kernels;
five percent to forty percent oil;
one half percent to eight percent turmeric;
less than one half percent to eight percent pepper; and,
one to thirteen percent additional seasoning.

6. Spicy popcorn as in claim 5 wherein the oil includes at least one of the following oils: palm oil, corn oil, vegetable oil, olive oil, canola oil, coconut oil, flax seed oil, grapeseed oil, hazelnut oil, peanut oil, safflower oil, sesame oil, sunflower oil, walnut oil, butter, clarified butter, rice bran oil, cottonseed oil, lard, margarine, diacylglycerol oil, soybean oil.

7. Spicy popcorn as in claim 5 wherein the pepper includes at least one of the following peppers: black pepper, red pepper, green pepper, jalapeno pepper, cayenne pepper, chili pepper, Serrano pepper, Tabasco pepper, Thai pepper, rocoto pepper.

8. Spicy popcorn as in claim 5 where the additional seasoning includes at least one of the following: salt, garlic, onion.

9. A method for preparing spicy popcorn comprising:
combining, in composition of weight, the following ingredients:
fifty percent to seventy percent corn kernels;
five percent to forty percent oil;
one half percent to eight percent turmeric;
less than one half percent to eight percent pepper; and,
one to thirteen percent additional seasoning.

10. A method as in claim 9 additionally comprising:
heating the combined ingredients so that a substantial portion of the corn kernels pop.

11. A method as in claim 9 wherein the method for preparing spicy popcorn wherein the corn kernels are popped before they are combined with other ingredients.

12. A method as in claim 9 wherein combining the ingredients includes the following substeps:
combining a subset of the ingredients, the subset including unpopped corn kernels;
popping the corn kernels;
adding in remaining ingredients to form combined ingredients.

13. A method as in claim 9 additionally comprising:
heating the combined ingredients in a microwave oven so that a substantial portion of the corn kernels pop.

14. A method as in claim 9 additionally comprising:
heating the combined ingredients in a kettle so that a substantial portion of the corn kernels pop.

15. A method as in claim 9 additionally comprising:
heating the combined ingredients in a popcorn maker so that a substantial portion of the corn kernels pop.

16. A method as in claim 9 wherein the cooking oil includes at least one of the following cooking oils: palm oil, corn oil, vegetable oil, olive oil, canola oil, coconut oil, flax seed oil, grapeseed oil, hazelnut oil, peanut oil, safflower oil, sesame oil, sunflower oil, walnut oil, butter, clarified butter, rice bran oil, cottonseed oil, lard, margarine, diacylglycerol oil, soybean oil.

17. A method as in claim 9 wherein the pepper includes at least one of the following peppers: black pepper, red pepper, green pepper, jalapeno pepper, cayenne pepper, chili pepper, Serrano pepper, Tabasco pepper, Thai pepper, rocoto pepper.

18. A method as in claim 9 wherein the additional seasoning includes at least one of the following: salt, garlic, onion.
